(19) United States
(12) Patent Application Publication
(10) Pub. No.: US 2006/0254853 A1
(43) Pub. Date: Nov. 16, 2006

(54) Track audio system

(76) Inventor: David Van Gieson, (US)

Correspondence Address: English & Associates, Attorneys at Law;County Square Professional Offices, Suite 101, 674 County Square Drive, Ventura, CA, 93003, US

(21) Appl. No.: 11/125,468

(22) Filed: May 10, 2005

(51) Int. Cl. G10K 11/00

(52) U.S. Cl. 181/191

(57) ABSTRACT

An audio track system that includes a track mounting fixture for audio speakers including a sliding member to be mounted in a track lighting fixture and constructed to retain audio speakers. Contact members on the sliding member contact conductive strips within a channel on the track member and supply electrical connection of the speakers to a sound system receiver and allowing the speakers to be positioned at any desired position along the channel length. The speaker position may be adjusted easily by sliding the sliding member along the channel and by pivoting the speaker about a joint on the sliding member.

### FIELD OF THE INVENTION

This invention relates generally to the field of audio systems, and more specifically to a track system that allows for movable speaker fixtures with features permitting the speakers to be slidably mounted in a track lighting type support fixture.

### BACKGROUND OF THE INVENTION

Speakers are widely used for providing projection of voice and music in a variety of areas and for numerous purposes. Prior art in the field includes various speakers that have been disclosed for mounting on a ceiling. It is well known in the art that speakers that are located at higher elevations in a room provide greater sound dispersion.

The desired projection of sound in a room can be modified by reorientation of speakers. However, much prior art focuses on speaker assemblies adapted to support a single speaker, the mounting of a speaker to an existing acoustic ceiling tile, and/or enclosing the rear of the speaker in a large or bulky enclosure. These ceiling suspended speakers are typically difficult to reorient. Additionally, prior art speakers used to produce a large volume of sound are typically bulky and cumbersome.

Typically, a great deal of manual effort is expended during adjustment of speaker position since the entire speaker and support structure must be manually lifted and moved to the new orientation. Additionally, cumbersome power lines to the receiver must be re-routed and/or adjusted. There is a need for mounting configurations that are adaptable to suspend the speakers from a ceiling, wall or standing floor device in overhead positions.

A large amount of effort is typically expended during the installation of a speaker mounting arrangement on ceilings and walls. Elaborate mounting hardware must be installed to support and provide power to the speakers. The complexity of such hardware renders movement or re-installation of the speakers to a new location prohibitively difficult. It is therefore desirable to incorporate features making the speaker mounting arrangement readily adaptable to structures that are already in place such as track lighting type support fixtures thereby eliminating the need to install separate mounting hardware. Furthermore, there is a need for a speaker mounting arrangement that permits adjustment of the speakers relative to the support fixture so that speaker position may be altered without reconfiguration or movement of the support fixture.

There is thus a need for a speaker mounting structure that is adaptable to a ceiling, wall or floor mounting and permits a high degree of speaker mobility while providing safe, simple and dependable adjustment of speaker position. A requisite feature of such a mounting arrangement must include ease of installation on a ceiling, wall, or floor standing media, and provide adaptability to mounting hardware that is already in place, i.e., track lighting support fixtures that can be adapted to mount and connect the speakers to a sound system receiver.

Turning to the relevant prior art, U.S. Pat. No. 6,738,483 by Betts teaches of an overhead loudspeaker system that manipulates sound waves for optimum sound. This system provides for improved sound quality in a low ceiling, but is still complex, cumbersome and difficult to adjust. U.S. Pat. No. 5,088,574 by Kertesz III teaches of a pyramidal housing supporting an array of four coaxial two-way loudspeakers. Like the Betts invention, the Kertesz III invention provides for improved sound quality, but it also suffers from similar drawbacks as it is complex, cumbersome and difficult to adjust. Similarly, U.S. Pat. No. 4,923,032 by Nuernberger teaches of a rectangular mounting panel speaker system with supporting gridwork for a suspended ceiling in place of conventional acoustic ceiling tile. As with the previous two inventions, this invention is limited due to its complexity, bulkiness and difficulty in adjustment.

U.S. Pat No. 6,719,255 by Chen discloses a suspending device for fixtures such as speakers. This invention has the feature of rendering the suspended fixture adjustably rotatable. However, this invention suffers from the fact that the position of the suspended speaker fixture, while rotatable as to the direction that the speaker faces, it is not adjustable as to its position in the room with the removal of the device and the affixing means. Similarly, U.S. Pat. No. 4,928,914 by Snodell provides a system that adjustably secures a speaker or other appliance on a wall or ceiling. However, the apparatus is likewise lacking in that it is not adjustable as to its position in the room without the removal of the apparatus and affixing means. Furthermore, the apparatus only holds one speakerw.

### SUMMARY OF THE INVENTION

In the preferred embodiment of the invention, suspended adjustable speakers are attached to a track system, adapted from existing devices that are used to activate track lighting fixtures. The system provides for efficient and universal sound in an enclosed area, such as a room, recording studio or concert venue. The tracks are then attached to a receiver in a sound system for sound projection throughout an enclosed area, such as a room, recording studio or concert venue.

In an alternative embodiment of the invention, where the enclosed area is of a particularly large space, a fiber optic delivery system can be used to disperse the sound in the track system rather than copper electrical wires to eliminate sound delays often found in large open spaces.

### OBJECTS OF THE INVENTION

The principal object of the invention is to provide a means for which an audio system is suspended overhead, on walls or on standing media in such a manner as to enable the positioning of the speaker or speakers to project sound in directions over a 360 degree angular range thereby dispersing efficient surround sound in an enclosed space.

It is a further object of the invention to adapt conventional track mounting fixtures to provide a dependable and stable mounting of speaker fixtures on such devices.

These objectives are realized in accordance with the present invention by means of a base member constructed to be mounted within a track lighting support fixture and having an end adapted to hold a speaker fixture, including means for adapting the power supply system found in conventional track lighting systems for connection of the track to a sound system receiver.

Numerous other advantages and features of and various means for practicing the invention will become apparent from the detailed description of the preferred embodiment of the invention, from the claims, and from the accompanying drawings, in which like numerals are used to designate like parts shown in different figures.

### BRIEF DESCRIPTION OF THE DRAWINGS

FIG. 1 illustrates a perspective view of the invention fully assembled with an example of three differing speaker housings suspended from the base track mounting fixture.

FIG. 2 illustrates a side, elevational view of the attachment housing device connecting the speaker fixtures to the base track fixture.

FIG. 3 illustrates a perspective, exploded view of the attachment housing device, clearly indicating assemblage of elements therein.

FIG. 4 illustrates a top, longitudinal, plan view of the base track mounting fixture with a cross section 5 thereof.

FIG. 5 illustrates a cross-sectional view of a conventional base track mounting fixture indicating opposed positive and negative terminals and a common ground element.

### DETAILED DESCRIPTION OF AN ENABLING AND PREFERRED EMBODIMENT

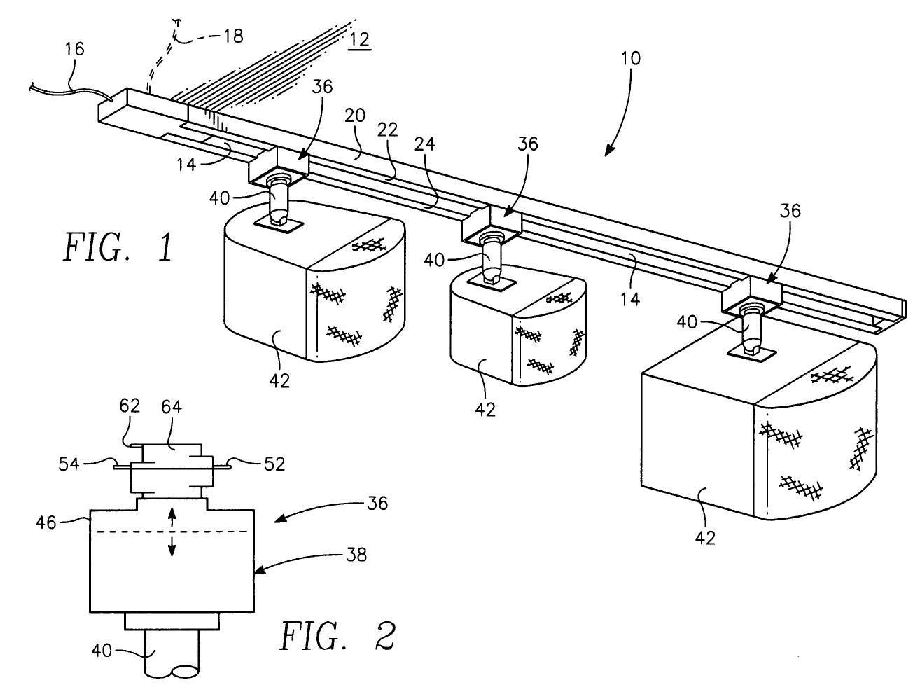

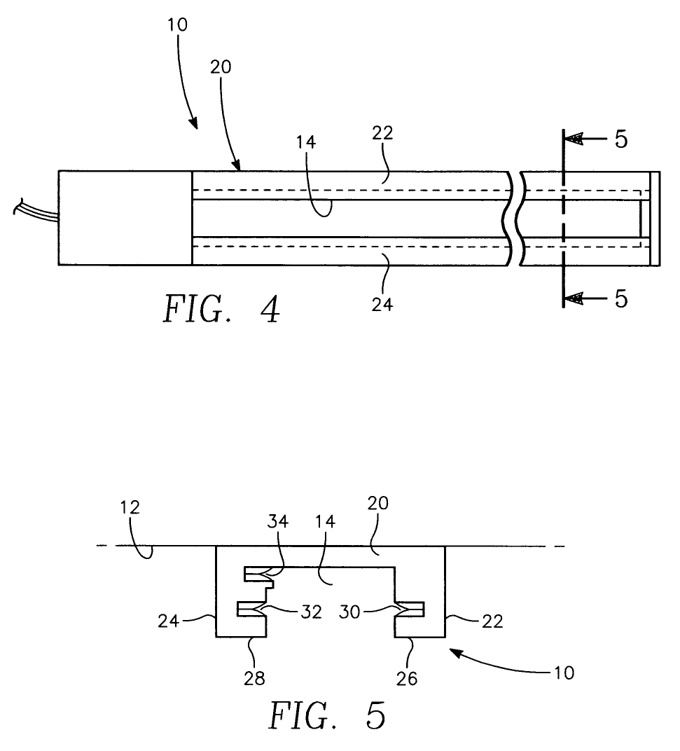

FIGS. 1-5 illustrate a preferred embodiment of the invention including the depiction of one of a plurality of base track members 10 typically attached to a ceiling 12 wherein each track member 10 contains a channel element 14 and electrical wires 16 connecting tack member 10 to a typical sound system or console (not shown) wherein the console and track member 10 may be connected through either the exposed connection 16 or via a hidden wire option 18.

Channel element 14 is comprised of a planar base element 20 with two lateral elements 22 and 24 extending substantially perpendicular to base element 20. Two ledge elements 26 and 28 extend substantially perpendicular to the lateral elements 22 and 24 and towards each other.

The base element 20 together with lateral elements 22 and 24 and ledge elements 26 and 28 define a generally C-shaped cross-section as shown in FIG. 5. Track member 10 further includes at least two conductive strips 30 and 32, as shown in FIG. 5, that extend longitudinally along ledge elements 26 and 28 and are connected to electrical lead 16 which again connects base track member 10 to a sound system, console. An additional conductive strip 34 follows conductive strip 32 along track member 10 to provide for a common ground for the overall speaker system.

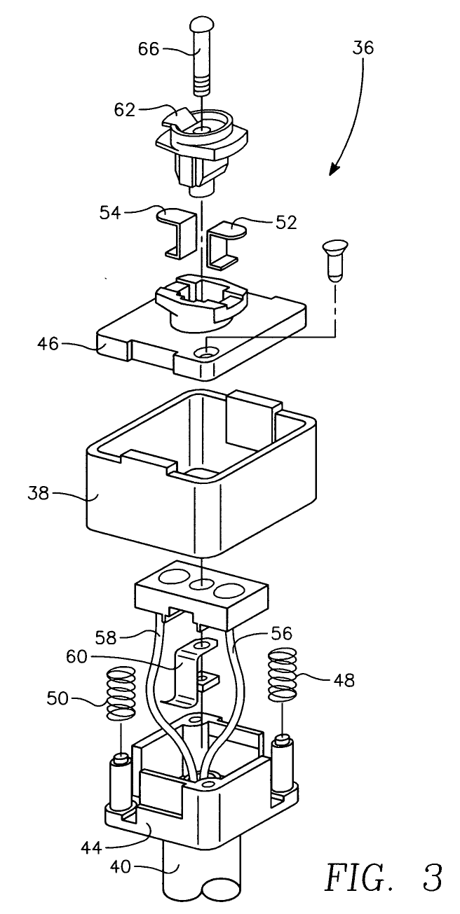

Referring now to FIG. 3, the speaker track system invention 10 further comprises a sliding speaker connecting element 36 consisting of a housing element 38 which is permitted to rotate on a fixed axis element 40 which is conventionally coupled to a speaker box 42 of various configurations or designs, thereby permitting various speakers 42 to be rotated and positioned at will in all directions. Housing element 38 further comprises a housing base 44, affixed to axis element 40, and a retaining housing lid 46, vertically sliding within housing 38 and connected to base element 44. Spring elements 48 and 50, in conjunction with sliding electrical contacts 52 and 54, hold connecting element 36 slidably yet firmly within channel element 14 located inside base track member 10. A pair of speaker 42 wires 56 and 58 are configured to make contact with contact sliding electrical contacts 52 and 54, respectively, which in turn make slidable contact with electrical leads 30 and 32, respectively, to complete the closed circuit between speakers 42 and the console power device. A conventional common ground contact, if used, is provided by speaker connecting element 36 via an internal common ground element 60 which is coupled to sliding ground element 62 which is secured within housing 38 by a ground seating element 64 secured by a screw 66.

The preferred embodiment includes at least one speaker 42 which can be adjustably positioned and connected to the conductive strips 30 and 32. The invention can be connected to a sound system receiver either through a plurality of electrically conductive metal elements, such as copper wire as illustrated, or in the case of a system existing in a very large enclosed area, the electrical connecting means 16 can include the implementation of a fiber optic delivery system, infra red, or radio frequency delivery means well known in the art.

The illustrations and examples provided herein are for explanatory purposes and are not intended to limit the scope of the appended claims. This disclosure is to be considered as an exemplification of the principles of the invention and is not intended to limit the spirit and scope of the invention or claims of the embodiment illustrated. Those skilled in the art will make modifications to the invention for particular applications of the audio track system.

I claim:

1. A track mounted audio system comprising:
at least one base track member, said track member including a channel element and means for connecting said track member to a receiver console at said receiver's speaker connection, said channel element further comprising:
a planar base element;
at least two lateral elements extending substantially perpendicular to said base element;
two support lip elements extending perpendicular to said lateral elements and towards each other;
said base element, lateral elements, and support lip elements defining a generally C-shaped cross-section;
said track member further including at least two conductive strips extending longitudinally along said support lip elements;
a sliding speaker connecting element coupled to said track element, comprising:
a housing element;
a base element coupled to said housing;
an axis element coupling said base element to a speaker;
a retaining housing lid element connected to said base and having at least two electrical contact members which make sliding contact with said conductive strips;

2. The track mounted audio system according to claim 1 wherein said means connecting said track members to a receiver comprises a plurality of electrically conductive metal filaments, such as copper wire.

3. A track mounted audio system according to claim 1 wherein said means connecting said track members to a receiver comprises a fiber optic system.

4. A track mounted audio system according to claim 1 wherein said means connecting said track members is hidden above a ceiling.

5. A track mounted audio system according to claim 1 wherein said means connecting said track members is an infra red system.

6. A track mounted audio system according to claim 1 wherein said means connecting said track members is a radio frequency system.

7. A method for producing significantly improved sound quality from a sound system comprising:
attachment of at least one track element to a ceiling, wall, and other supporting structure, each track element including a channel element and a means for connecting said track element to a receiver console, said channel element comprising:
a planar base element;
two lateral elements extending substantially perpendicular to said base element;
two support lip elements extending perpendicular to said lateral elements and towards each other;
said track members further including at least two conductive strips extending longitudinally along said channel element and coupled to said receiver console;
attachment of a sliding member to said track member, said sliding member comprising:
a base element, said base element having an axis;
a retaining element connected to said base element and having at least two contact members which contact said conductive strips;
means for biasing said contact members, in a direction parallel to said base element axis, against said conductive strips.

8. A method for producing significantly improved sound quality from a sound system according to claim 5 wherein said means connecting said track members to a receiver comprises a plurality of electrically conductive metal filaments, such as copper wire.
